(19) United States
(12) Patent Application Publication
(10) Pub. No.: US 2002/0154777 A1
(43) Pub. Date: Oct. 24, 2002

(54) System and method for authenticating the location of content players

(76) Inventor: Brant Lindsey Candelore, Escondido, CA (US)

Correspondence Address: SKJERVEN MORRILL LLP, 25 METRO DRIVE, SUITE 700, SAN JOSE, CA, 95110, US

(21) Appl. No.: 09/840,226

(22) Filed: Apr. 23, 2001

(51) Int. Cl. H04K 1/00

(52) U.S. Cl. 380/258

(57) ABSTRACT

A system and method for authenticating the location of content players are provided. One aspect of the system comprises a content processing device, which comprises a descrambler, a GPS receiver and a processor. The content processing device processes scrambled content signals from an Internet connection, a satellite, a cable network, a terrestrial stream or a packaged media. The GPS receiver receives a plurality of GPS signals and determines a location of the GPS receiver. The processor may check a time generated by the GPS receiver with a secure time source to verify the validity of the GPS location. The processor then compares the location determined by the GPS receiver with pre-determined access criteria. If the location determined by the GPS receiver meets the access criteria, the processor allows the descrambler to descramble the content signals.

### BACKGROUND OF THE INVENTION

1. Field of the Invention

The present invention relates to content players, and more particularly, to systems and methods of authenticating the location of content players.

2. Description of the Related Art

Content providers are concerned with unauthorized use of their content, such as movies and televised sporting events. For example, cinematic release dates for various markets, such as theaters, video rental market, and electronic delivery via the Internet, satellite, phone, cable and terrestrial broadcast, are phased throughout the world. For each of these markets, the United States typically receives movie releases first, Europe second, while the rest of the world receives them later.

One problem relates to movies that are sent outside of their intended viewing area and played ahead of the scheduled release date. Content providers do not want a movie that was intended for a United States movie release to be shown in other parts of the world ahead of its intended schedule.

Another problem is misappropriation of a program signal intended for a home content player for commercial use. Direct Broadcast Satellite (DBS) as well as terrestrial and cable receiver/players, e.g., set top boxes, typically receive signals in a large broadcast area. The signals are received by commercial as well as residential customers. A home customer typically pays a lot less than a commercial establishment, such as a restaurant or bar, to receive and view a program, such as a pay-per-view college football game or a boxing event. The commercial establishment typically pays according to the fire occupancy limit of the establishment. Sometimes, commercial establishments are not authorized to receive a particular program or pay-per-view event because there are alternate commercial viewing locations, such as an auditorium, stadium or arena, where the live event or broadcasted program may be viewed.

If a commercial establishment somehow receives a pay-per-view event that is not authorized for commercial viewing, then the pay-per-view event may place that particular commercial establishment in a more competitive position compared to other commercial establishments. Providing unauthorized pay-per-view events may gain the loyalty of customers and be very lucrative for the commercial establishment, which charges a cover charge for the events and sells food and beverages. Thus, there may be a tremendous financial incentive for a commercial establishment to cheat and use a content player that is authorized for home use in the commercial establishment.

Movie distributors that have authorized a movie to be shown in a particular type of theater or on a particular theater screen, e.g., IMAX, face another problem. The theater owner can take the movie to a different location and show it on a different theater screen. The quality of the viewing may not be what the distributor wanted. And the movie distributor may not be compensated for the viewing in the unauthorized location, especially if the movie distributor does not learn of the viewing.

Another problem is enforcing black-outs in a particular area. In broadcast distribution, content players in black-out areas as well as non-black-out areas can receive the same signals. It may not be possible to restrict the transmission of signals in certain geographical locations. A customer will typically tell the service operator the location of the customer's content player. This is typically the customer's home and billing address. The service operator must often take it on faith that the content player is actually at that location, and that the content player will not be moved. However, a content player that has been authorized for viewing in a particular location, e.g. the customer's home, may be taken to a different area where a sporting event is blacked-out. For example, a satellite set top box (STB) may be taken out of its registered area, to either a home or commercial establishment in order to avoid a sports blackout in the different area of the home or commercial establishment. If no other commercial establishments are able to show the program in a particular area, then the establishment with the unauthorized satellite set top box, which is able to show the sporting event, may gain a commercial advantage.

Another problem is gray market decoders. Canadian and Mexican residents often purchase satellite dishes, set top boxes and content players (decoders) in the United States, which have been authorized for use only in the United States, and then take them to Canada or Mexico. The satellite dishes, set top boxes and content players receive signals from U.S. service providers, such as DirecTV or EchoStar. The Canadian and Mexican residents often cannot receive specific programming from a company that has been licensed in their own country. The U.S. service providers, such as DirecTV or EchoStar, however, may not have copyright licenses to sell programming in Canada and Mexico. In recent years, Canadians have been able to purchase satellite service from Express View. But that service is not as compelling as DirecTV or EchoStar, and therefore Canadian customers often subscribe as U.S. customers in order to get programming from DirecTV or EchoStar. When Canadian and Mexican residents purchase and receive content from service providers outside their licensed areas, the legitimate license holder, e.g., Express View, is at a competitive disadvantage.

Likewise, packaged media, e.g. video tapes and DVDs, are released in a similar fashion as cinematic releases in theaters. The packaged media are coded with ‘regional coding’ to prevent the packaged media from being played by content players, such as Divix and DVD players, that are made for certain countries. Consumers in countries other than the U.S. have overcome the ‘regional coding’ of DVDs by purchasing a DVD content player purchased in the U.S., along with the necessary power adapters and even NTSC TV, in order to play the movies in their respective countries.

### SUMMARY OF THE INVENTION

Each content receiver, content player and packaged media player determines its physical location on its own. After comparing that determined location with access criteria, the device can decide whether or not it is authorized to decode or descramble content that has been received or read from a media at that particular location.

Systems and methods for authenticating the location of content players are provided in accordance with the present invention. In one embodiment, a Global Positioning System (GPS) receiver is implemented in a content receiver/player to authenticate the location of the content player. GPS signals are sent from GPS satellites that may be about 11,000 miles in space to the GPS receiver in the content player within a particular time window. If the location of the GPS receiver meets certain predetermined criteria (i.e., matches an authorized location or is not in a black-out location), and the content player is otherwise authorized to play content signals, the content player will descramble the content.

The location-authenticating systems and methods may facilitate electronic distribution of movies to movie theatres across the world. Instead of sending reels of celluloid tape out to theatres, movies could be sent digitally through various distribution modes, such as DBS, phone, Internet, over-the-air and cable.

One aspect of the invention relates to a system for using Global Positioning System (GPS) location as access criteria for content. The system comprises a content source unit, an access criteria unit and a processor. The content source unit is configured to produce content signals. The access criteria unit is configured to produce access criteria, which specifies at least one pre-determined GPS location where a content receiver is authorized to descramble content signals. The processor is coupled to the content source and the access criteria unit. The processor is configured to associate access criteria from the access criteria unit with content signals from the content source unit. The processor is configured to scramble the content signals.

For broadcast or electronic delivery networks, a transmitter is coupled to the processor. The transmitter is configured to transmit the scrambled content signals and the access criteria to at least one content receiver.

For packaged media, a media writer is coupled to the processor. The media writer is configured to write the scrambled content onto tapes, discs or other suitable media. The media may be sold in stores, rented, played by customers with content players and programmed in a device at a customer's home after a download.

Another aspect of the invention relates to a content processing device comprising a descrambler, a means for autonomously determining location and a processor. The descrambler is configured to descramble scrambled content signals. The processor is coupled to the means for autonomously determining location and the descrambler. The processor is configured to compare the location determined by the means for autonomously determining location with predetermined access criteria. If the location determined by the means for autonomously determining location meets the access criteria, then the processor allows the descrambler to descramble content signals. If the location determined by the means for autonomously determining location does not meet the access criteria, then the processor prevents the descrambler from descrambling content signals.

In one embodiment, the means for autonomously determining location comprises a Global Positioning System (GPS) receiver. The GPS receiver is configured to receive a plurality of GPS signals from a plurality of GPS satellites and determine a location of the GPS receiver based on the GPS signals. In another embodiment, the means for autonomously determining location comprises a cellular receiver.

In one embodiment, the content processing device further comprises a receiver coupled to the descrambler. The receiver is configured to receive scrambled content from a content provider. In another embodiment, the content processing device further comprises a media reader coupled to the descrambler. The media reader is configured to read scrambled content from a media.

Another aspect of the invention relates to a method of authenticating the location of a content player. The method comprises associating access criteria with content signals, where the access criteria comprises at least one predetermined Global Positioning System (GPS) location where a content player is authorized to decode content signals; coding the content signals to prevent unauthorized content players from accessing the content signals; and transmitting the content signals with the access criteria to at least one content player.

Another aspect of the invention relates to a method of authenticating the location of a content player. The method comprises receiving a plurality of GPS signals from a plurality of GPS satellites at a content player; determining a location of the content player based on the GPS signals; and comparing the location based on the GPS signals with predetermined access criteria, wherein (a) if the location based on the GPS signals meets the access criteria, then descrambling the content signals, and (b) if the location based on the GPS signals does not meet the access criteria, then preventing the content signals from being descrambled.

In one embodiment, the method further comprises receiving scrambled content signals from a content provider at a content player. In another embodiment, the method further comprises reading scrambled content from a media.

Another aspect of the invention relates to a method of discarding GPS location signals that have been falsely simulated (also called ‘spoofing’). The method comprises accessing an independent, secure source of time and comparing the secure time source against a time derived and output by the GPS receiver. If the time output by the GPS receiver is within a predetermined range of the secure time source, then scrambled content may be descrambled. By determining a difference between the time output by the GPS receiver and the secure time source, the content player is more adapted to discriminate between simulated signals from a GPS simulator and actual GPS signals coming from the GPS satellites.

Another aspect of the invention relates to a conditional access device. The conditional access device comprises a content descrambler configured to descramble scrambled content signals and a means of autonomously determining a location of the descrambler. In one embodiment, the means of autonomously determining a location of the descrambler comprises a GPS receiver that is integrated in or closely coupled to a descrambler. In one embodiment, the device is housed in a portable module, e.g., a PCMCIA module. The PCMCIA module may be plugged into or coupled to a content player.

### BRIEF DESCRIPTION OF THE DRAWINGS

FIG. 1 illustrates one embodiment of a content transmission system.

FIG. 2 illustrates one embodiment of a content processing device in the system of FIG. 1.

FIG. 3 illustrates one embodiment of a content provider system, which sends content signals to the content receiver/player of FIG. 2.

### DETAILED DESCRIPTION

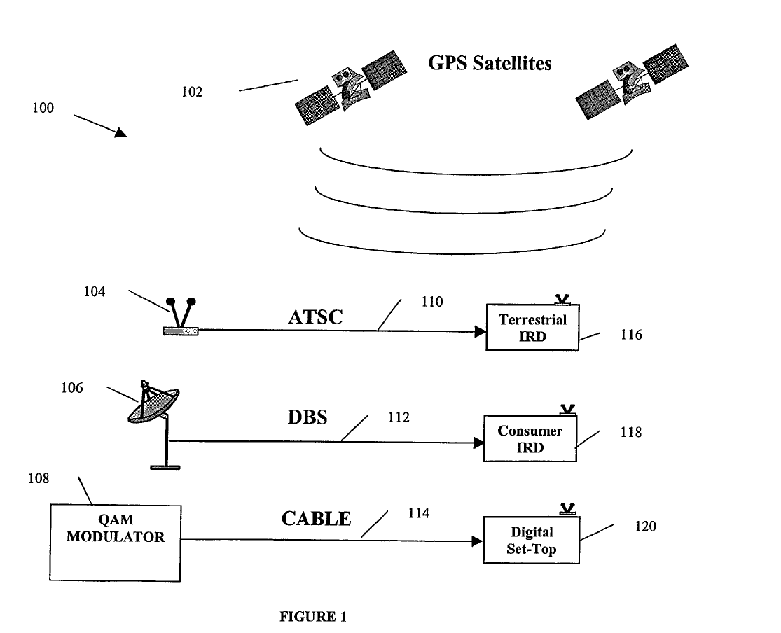

FIG. 1 illustrates one embodiment of a content transmission system 100. The content transmission system 100 comprises a plurality of Global Positioning System (GPS) satellites 102, an Advanced Television Systems Committee (ATSC) transmitter 104, an ATSC communication path 110, one or more terrestrial integrated receivers/descramblers (IRDs) 116, a Direct Broadcast Satellite (DSB) dish 106, a DBS communication path 112, one or more consumer IRDs 118, a quadrature amplitude modulation (QAM) modulator 108, a cable 114 and one or more digital set-top boxes (STBs) 120.

The ATSC transmitter 104 in FIG. 1 transmits content signals, such as Advanced TV (ATV), Digital TV (DTV) or High Definition TV (HDTV) signals, via the ATSC path 110 to one or more terrestrial IRDs 116. The DBS dish 106 transmits content signals via the DBS path 112 to one or more consumer IRDs 118. The QAM modulator 108 transmits content signals via the cable 114 to one or more digital set-top boxes 120. The system 100 in FIG. 1 may have any number of ATSC transmitters 104, DBS dishes 106, QAM modulators 108, terrestrial IRDs 116, consumer IRDs 118 and digital set-top boxes 120.

The IRDs 116, 118 and STBs 120 in FIG. 1 are configured to receive and decode encrypted or scrambled signals transmitted by the ATSC transmitter 104, the DBS dish 106 and the QAM modulator 108, respectively. The IRDs 116, 118 and the STBs 120 may be referred to herein as ‘content receivers,’ ‘content players,’ or ‘content processing devices.’ The content receivers/players 116-120 in FIG. 1 may be used in any suitable location, such as a residence, a vehicle or a business, such as a movie theater, a bar or a restaurant. The content receivers/players 116-120 in FIG. 1 each contain a GPS receiver, as described below, which may be used to authenticate the locations of the content receivers/players 116-120.

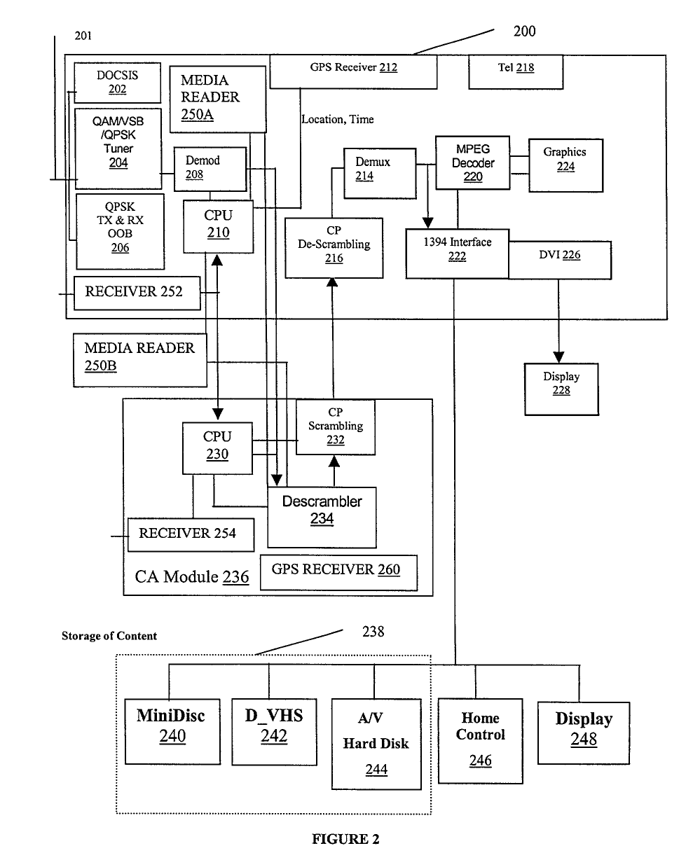

FIG. 2 illustrates one embodiment of a content processing device 200 in the system 100 of FIG. 1. The content processing device 200 may comprise a content receiver, such as a set-top box, a content player, such as a DVD player, or both. Thus, the content processing device 200 may be referred to herein as a ‘content receiver,’ a ‘content player’ or both. The content receiver/player 200 of FIG. 2 may represent the terrestrial IRD 116, the consumer IRD 118, the digital set-top box 120 or a combination of the IRDs 116, 118 and the set-top box 120 in FIG. 1.

The content processing device 200 in FIG. 2 may interface with a conditional access (CA) module 236, a MiniDisc player 240, a digital VHS (D-VHS) player 242, an audio/video (A/V) hard disk player 244, a home control unit 246, a first display 248, external media reader 250B and/or a second display 228. In one embodiment, the CA module 236 is integrated with the content receiver/player 200.

The content receiver/player 200 in FIG. 2 comprises an antenna or port 201, such as a coaxial cable, a Data Over Cable Systems Interface Specifications (DOCSIS) or CableLabs Certified Cable Modem 202, a QAM/vestigial sideband (VSB)/quatemary phase shift keying (QPSK) tuner 204, a QPSK transmitter and receiver out-of-band (OOB) unit 206, a demodulator 208, a central processing unit (CPU) 210 (also called a ‘host CPU 210’ or ‘main CPU 210’), a GPS receiver 212, a CP de-scrambling unit 216, a demultiplexer (DEMUX) 214, a telephone port 218, a Moving Pictures Experts Group (MPEG) decoder 220, an IEEE 1394 bus interface 222, a graphics unit 224, a Digital Video Interface (DVI) unit 226, a media reader 250A and an access criteria receiver 252.

In one embodiment, the cryptographic CPU 230 in FIG. 2 is housed in an integrated circuit (IC), such as a smart card IC. In one embodiment, the GPS receiver 212 is part of a GPS module that is separate from the content receiver/player 200 in FIG. 2. The main CPU 210 interacts with the GPS unit, whether a module or embedded in the player/receiver, and passes the GPS location information to the cryptographic CPU 230.

Other embodiments of the content receiver/player 200 may not comprise all of the components listed above. For example, one embodiment of the content receiver/player 200 in FIG. 2 comprises either a DOCSIS modem 202, a QAM/VSB/QPSK tuner 204 or a QPSK transmitter and receiver OOB unit 206, but not all three components. As another example, one embodiment of the content receiver/player 200 communicates with an external media reader 250B and does not have an internal media reader 250A. As another example, one embodiment of the content receiver/player 200 receives access criteria with the content signals and does not have an access criteria receiver 252. Other embodiments of the content receiver/player 200 may comprise additional components instead of or in addition to the components listed above.

In FIG. 2, the DOCSIS modem 202, QAM/VSB/QPSK tuner 204 and QPSK transmitter and receiver OOB unit 206 are configured to receive various content signals (e.g., cable, terrestrial, DBS) via antenna/port 201 transmitted by one or more content providers with the ATSC transmitter 104, the DBS dish 106 and the QAM modulator 108 of FIG. 1. The content providers, such as a cable TV operator, typically modulate the content signals for transmission. For example, the signals may be formatted according to 8-VSB, which is a standard radio frequency (RF) modulation format used by ATSC for transmitting digital TV (DTV) signals. The content providers may also scramble/encrypt the content signals in an attempt to prevent unauthorized reception.

The demodulator 208 in FIG. 1 demodulates the content signals received by the DOCSIS modem 202, QAM/VSB/QPSK tuner 204 and/or QPSK transmitter and receiver OOB unit 206. The demodulator 208 transfers the demodulated content signals to the descrambler 234 in the CA module 236.

In addition to or instead of the signals from the demodulator 208, the media reader 250A or 250B in FIG. 2 may transfer scrambled content signals to the descrambler 234 in the CA module 236. The media readers 250A and 250B are configured to read scrambled content from a media, such as a cassette tape, CD, floppy disk or DVD and transfer the read content to the descrambler 234.

The CA module 236 in FIG. 2 may comprise a Point of Deployment (POD) conditional access module, a National Renewable Security System part B (NRSS-B), a Digital Video Broadcasting (DVB) Common Interface module (e.g., used in Europe) or a portable module such as a Personal Computer Memory Card International Association (PCMCIA) type 2 form factor. The CA module 236 comprises a CPU 230, a copy protection (CP) scrambling unit 232, a descrambler 234 and an access criteria receiver 254. Other embodiments of the CA module 236 may not comprise all of the components shown in FIG. 2. For example, one embodiment of the CA module 236 does not have an access criteria receiver 254. Other embodiments of the CA module 236 may comprise other components, such as a GPS receiver 260, in addition to or instead of the components shown in FIG. 2. Thus, in one embodiment, the GPS receiver 260 is physically located in the CA module 236 instead of a GPD receiver 212 in the player/receiver 201. In another embodiment, the GPS receiver 212 is closely coupled with the CA module 236.

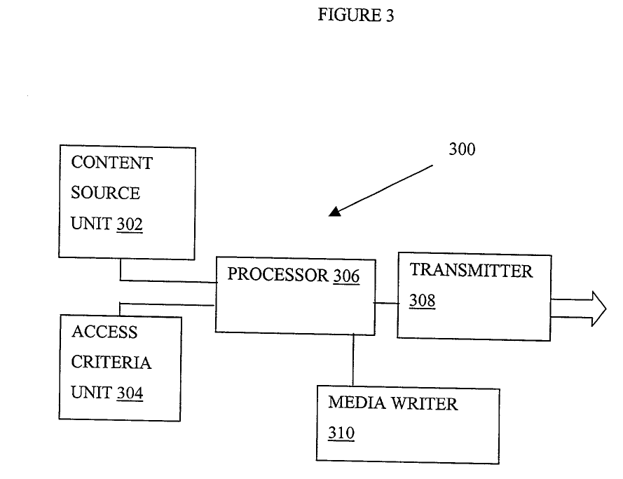

In one embodiment, a content provider creates access criteria and transmits the access criteria in-band with content signals to the content receiver/player 200, as described below with reference to FIG. 3. For example, the access criteria may be ‘meta-data.’ In one embodiment, the demodulator 208 in FIG. 2 transfers the content signals and the access criteria to the CPU 210, which transfers the content signals and the access criteria to the cryptographic CPU 230. In another embodiment, the demodulator 208 transfers the access criteria and/or any entitlements associated with the content directly to the CA module 236.

The cryptographic CPU 230 processes access criteria in the content signals. In one embodiment, the CPU 230 stores the access criteria. In one embodiment, the CPU 230 derives any content keys, i.e., entitlement control messages (ECM), from the access criteria. In this embodiment, the CPU 230 sends the keys to the descrambler 234 to descramble the content.

In another embodiment, a content provider transmits the access criteria independently of the content signals to the receiver 254 in FIG. 2, which transfers the access criteria to the CPU 230. The CPU 230 processes the access criteria. In another embodiment, a content provider transmits access criteria to the receiver 252 in FIG. 2, which transfers the access criteria to the CPU 230.

The access criteria may comprise ‘positive,’ ‘negative’ or ‘positive and negative’ access criteria. ‘Positive’ access criteria specify one or more locations or regions where one or more content receivers/players 200 are authorized to descramble content, such as a video-on-demand (VOD) program. In one embodiment, the content is intended for a particular content receiver/player 200 in a particular location or region. ‘Negative’ access criteria specify one or more locations or regions where one or more content receivers/players 200 are not authorized to descramble content. If a receiver/player 200 is not in one or more pre-determined specified locations or regions, then the receiver/player 200 may descramble the received content. ‘Positive and negative’ access criteria specify at least one location where at least one content receiver 200 is authorized to descramble content signals and at least one location where at least one content receiver 200 is not authorized to descramble content signals The access criteria may comprise a relatively long list of authorized and/or unauthorized locations or regions. The access criteria may also comprise a time period when a content receiver 200 is authorized or not authorized to descramble content signals.

In another embodiment, a content provider sends the access criteria to the content receiver/player 200 and/or the CA module 236 independently of the content signals. In another embodiment, the access criteria are pre-stored in the content receiver/player 200 when the content receiver/player is manufactured.

The CPU 230 in FIG. 2 may also process entitlement information and enforce the business rules of a service provider, such as a cable operator with monthly subscriptions. For example, the CPU 230 will grant a content receiver/player 200 access to content signals after the CPU 230 receives authorization from the cable operator that the customer has paid a monthly bill.

The GPS receiver 212 in FIG. 2 receives a GPS signal from a plurality of GPS satellites 102 (FIG. 1) and determines the location of the content receiver/player 200. The GPS receiver 212 sends the location data to the CPU 210 automatically or upon a request from the CPU 210. In one embodiment, the GPS receiver 212 receives a GPS signal within a particular time window, estimates a time when the signal was received and sends the estimated time with the location data to the CPU 210, which sends the estimated time with the location data to the cryptographic CPU 230. For example, the content receiver/player 200 may change locations from time to time or certain programming may be authorized from time to time. The GPS receiver 212 is not required to send both location and time data to the CPU 210, but location data used in conjunction with time data may improve the security of the content receiver/player 200.

If the CA module 236 has its own GPS receiver 260, the functions of the GPS receiver 260 are substantially similar to the GPS receiver 212, except the GPS receiver 260 sends an estimated time with location data directly to the CPU 230.

In one embodiment, the GPS receiver 212 or 260 has its own security perimeter. The GPS receiver 212 or 260 sends a cryptographic signature with the location and/or time data to the cryptographic CPU 230 to prevent a user from sending fake location and/or time data to the CPU 230. The signature comprises a secret or private key, such as a predetermined sequence of bits. In this embodiment, the CPU 230 has a corresponding secret or private key. If the signature from the GPS receiver 212 or 260 matches the key in the CPU 230, then the CPU 230 uses the location and/or time data to determine whether or not the received content signals should be descrambled. The GPS receiver212 or 260 is not required to send a cryptographic signature with the location and/or time data to the CPU 230, but the signature may improve the security of the content receiver/player 200.

In one embodiment, the cryptographic CPU 230 securely communicates using secret or public key cryptography to send a query and a nonce to the GPS receiver 212 or 260. A nonce is a ‘challenge’ or a random value generated fresh for each use and included in inter-processor exchanges to make each exchange unique. The GPS receiver 212 or 260 returns a response along with the location information securely to the cryptographic CPU 230. The response could be the original nonce value encrypted with the private key of the GPS receiver 212 or 260 (along with the location data). Alternatively, the response could be the nonce value hashed with the location data and then the hash encrypted with a shared secret key. The cryptographic processor 230 will examine the response from the GPS receiver 212 or 260 to see if the response is truly from the GPS receiver 212 or 260.

GPS simulators currently exist to test devices with GPS functions. For example, a GPS simulator may be coupled to the GPS receiver 212 or 260 in FIG. 2. The GPS simulator may be configured to simulate signals from satellites corresponding to any location in the world. GPS simulators are not commonly available, but they may be used to defeat the security of a GPS-based content receiver/player 200 system as outlined herein. GPS simulators generally provide highly accurate location signals, but do not provide a simulated, current time signal with the location signal.

In one embodiment, the GPS receiver 212 or 260 in FIG. 2 is configured to output a time signal that is associated with each derived location signal. The CPU 230 compares an independent, secure time source, preferably a local time source, with a time presumably output by the GPS receiver 212 or 260 to verify the authenticity of the location signal from the GPS receiver 212 or 260. If the time presumably output by the GPS receiver 212 or 260 is within a predetermined range of the independent time source, then the CPU 230 uses the GPS location signal from the GPS receiver 212 or 260. If the time presumably output by the GPS receiver 212 or 260 is outside of a predetermined range of the independent time source, then the CPU 230 discards the GPS location signal from the GPS receiver 212 or 260.

The cryptographic CPU 230 in FIG. 2 is a secure processor that communicates with the CPU 210 and the GPS receiver 212 or 260. The cryptographic CPU 230 receives location information from the CPU 210 or the GPS receiver 260 and determines whether the location of the content receiver/player 200 meets the access criteria (either positive or negative). As explained earlier, in one embodiment, the processor 230 uses a real-time clock (either an internal or an external clock) to authenticate the time of the location data from the GPS receiver 212 or 260. The CPU 230 informs the CPU 210 whether the content receiver/player 200 is authorized to access the received content signals. Determining whether a content receiver/player 200 is authorized to receive and play content may be referred to as an ‘authorization process.’ If access is granted, the cryptographic CPU 230 sends a decryption key (control signal) to the descrambler 234.

The descrambler 234 in FIG. 2 is configured to descramble content signals from the demodulator 208 or the media reader 250A or 250B. The Copy Protection (CP) scrambling unit 232 in FIG. 2 is configured to scramble content signals for copy protection to keep an eavesdropper from illegally copying the content descrambled by the descrambler 234, i.e., prevent a user from intercepting the content signals from the descrambler 234 to the content receiver/player 200 and making unauthorized copies of the content signals. The CP scrambling unit 232 sends copy protected content signals to the CP de-scrambling unit 216 in the content receiver 200. The CP de-scrambling unit 216 in FIG. 2 is configured to descramble the copy protection placed on the content signals by the CP scrambling unit 232.

The demultiplexer 214 in FIG. 2 demultiplexes the signals and passes the signals to the MPEG decoder 220 and the 1394 bus interface 222. The MPEG decoder 220 decompresses/decodes video signals and may access the graphics unit 224. The Digital Video Interface (DVI) unit 226 delivers decompressed signals to one or more displays 228. The IEEE 1394 bus interface 222 is configured to send decompressed, decoded content signals to the MiniDisc player 240, the D-VHS player 242 and/or the A/V hard disk player 244.

The MiniDisc player 240, D-VHS player 242, and A/V hard disk player 244 in FIG. 2 are configured to store content received by the content receiver 200 and later retrieve the content for playback. In one embodiment, the MiniDisc player 240, D-VHS player 242, and A/V hard disk player 244 in FIG. 2 are coupled together using an IEEE 1394 network and comprise a home network system 238. The displays 228, 248 in FIG. 2 are configured to display content, such as motion pictures, received by the content receiver 200.

The content signals output by content receiver/player 200 in FIG. 2 may have an assigned state of copy protection, which may be set by the CA module 236. For example, the content signals may have a ‘Copy Never’ state of copy protection, which prevents any form of copying. A ‘Copy Free’ state allows free copying. ‘Copy Once’ allows a onetime copy to be made. ‘Copy No More’ prevents further copying. There may be other states for certain technologies, e.g., for personal video recorders, one copy protection state may allow temporary storage, e.g., less than 40 minutes.

The home control unit 246 in FIG. 2 is configured to control household devices, such as lights, heat, air conditioning, an alarm system and devices such as the content receiver 200.

In one embodiment, GPS circuitry is embedded in or integrated with a cryptographic IC to perform the functions described above related to the content receiver 200. For example, a GPS chip, such as NAV-2100 or NAV-2300, made by Analog Devices, Inc. in Norwood, Mass., may be modified to include or operate with a RF front end and a GPS antenna. The NAV-2100 and NAV-2300 include a digital signal processor (DSP), an on-chip SRAM and a plurality of I/O peripherals. The NAV-2300 could be built into a cryptographic IC to perform the functions described above related to the content receiver 200.

In one embodiment, the content receiver/player 200 is configured to perform the functions of the CA module 236 described above, and a separate CA module 236 is not used.

FIG. 3 illustrates one embodiment of a content provider system 300, which sends content signals to the content receiver/player 200 of FIG. 2. The content provider system 300 comprises a content source unit 302, an access criteria unit 304, a processor 306 and a transmitter 308. The content source unit 302 comprises a storage device, such as one or more disk drives, disk arrays, computer servers or solid state memory, or a live content receiver, such as a camera at a sports event. Those skilled in the art will understand the functions of the content source unit 302, the processor 306 and the transmitter 308, except for the functions described herein.

The content source unit 302 in FIG. 3 provides content signals to the processor 306. The access criteria unit 304 in FIG. 3 provides access criteria, such as a predetermined location and/or time data, to the processor 306. The content provider, such as a cable or satellite company, may create and modify the access criteria.

The processor 306 in FIG. 3 associates the access criteria from the access criteria unit 304 with the content signals from the content source unit 302 and passes the access criteria and content signals to the transmitter 308. The processor 306, the content source unit 302 or the transmitter 308 may modulate the content signals for transmission and scramble/encode/encrypt the content signals to prevent unauthorized access to the content signals.

The transmitter 308 in FIG. 3 may represent the ATSC transmitter 104, DBS dish 106 or QAM modulator 108 of FIG. 1. The transmitter 308 transmits the content signals and access criteria to at least one content receiver/player 200 in FIG. 2. As described above, in another embodiment, the processor 306 and the transmitter 308 send access criteria to content processing devices independently of the content signals.

In another embodiment, the content provider system 300 in FIG. 3 comprises a media writer 310 coupled to the processor 306 instead of or in addition to the transmitter 308. The media writer 310 is configured to write scrambled content with access criteria from the processor 306 onto media, such as cassette tapes, compact discs (CDs) and digital video discs (DVDs). The media is sold in stores, rented, played by customers with content players or programmed in a device at a customer's home after a download.

The above-described embodiments of the present invention are merely meant to be illustrative and not limiting. Various changes and modifications may be made without departing from the invention in its broader aspects. For example, in one embodiment, cellular phone signals are received by the CA module 236 and used to determine a location of a content processing device 200 instead of GPS signals. The appended claims encompass such changes and modifications within the spirit and scope of the invention.

What is claimed is:

1. A system for using Global Positioning System (GPS) location as access criteria for content, the system comprising:
a content source unit configured to produce content signals;
an access criteria unit configured to produce access criteria, the access criteria specifying at least one pre-determined GPS location where a content receiver is authorized or not authorized to descramble content signals; and
a processor coupled to the content source and the access criteria unit, the processor being configured to associate access criteria from the access criteria unit with content signals from the content source unit, the processor being configured to scramble the content signals.

2. The system of claim 1, further comprising a transmitter coupled to the processor, the transmitter being configured to transmit the scrambled content signals and the access criteria to at least one content receiver.

3. The system of claim 1, wherein the transmitter is configured to transmit signals wirelessly to at least one content receiver.

4. The system of claim 1, wherein the transmitter comprises an Advanced Television Systems Committee (ATSC) transmitter.

5. The system of claim 1, wherein the transmitter comprises a Direct Broadcast Satellite (DBS) dish.

6. The system of claim 1, wherein the transmitter comprises an Internet connection.

7. The system of claim 1, wherein the transmitter is configured to transmit signals via a cable network to at least one content receiver.

8. The system of claim 7, wherein the transmitter comprises a quadrature amplitude modulation (QAM) modulator.

9. The system of claim 1, further comprising a media writer coupled to the processor, the media writer being configured to write the scrambled content signals and the access criteria from the processor to at least one media configured to be played by a content player.

10. The system of claim 1, wherein the content signals comprise a motion picture.

11. The system of claim 1, wherein the content signals comprise a sporting event.

12. The system of claim 1, wherein the content signals comprise a concert event.

13. The system of claim 1, wherein the access criteria further comprise a time period when a content receiver is authorized to descramble the content signal.

14. A content processing device comprising:
a descrambler, the descrambler being configured to descramble scrambled content signals;
a means for autonomously determining location;
a processor coupled to the means for autonomously determining location and the descrambling module, the processor being configured to compare the location determined by the means for autonomously determining location with pre-determined access criteria, wherein if the location determined by the means for autonomously determining location meets the access criteria, then the processor allows the descrambler to descramble content signals, and if the location determined by the means for autonomously determining location does not meet the access criteria, then the processor prevents the descrambler from descrambling content signals.

15. The content processing device of claim 14, wherein the means for autonomously determining location comprises a Global Positioning System (GPS) receiver configured to receive a plurality of GPS signals from a plurality of GPS satellites, the GPS receiver configured to determine a location of the GPS receiver based on the GPS signals.

16. The content processing device of claim 14, wherein the means for autonomously determining location comprises a cellular signal receiver.

17. The content processing device of claim 14, further comprising a receiver coupled to the descrambler, the receiver being configured to receive scrambled content signals from at least one content provider.

18. The content processing device of claim 14, further comprising a media reader coupled to the descrambler, the media reader being configured to read scrambled content from a media.

19. The content processing device of claim 14, wherein the access criteria are delivered with the content signals from the content provider.

20. The content processing device of claim 14, wherein the access criteria are delivered from the content provider independently of the content signals.

21. The content processing device of claim 14, wherein the access criteria are stored in the content processing device during manufacturing.

22. The content processing device of claim 14, wherein the access criteria specify at least one location where at least one content processing device is authorized to descramble content signals.

23. The content processing device of claim 14, wherein the access criteria specify at least one location where at least one content processing device is not authorized to descramble content signals.

24. The content processing device of claim 14, wherein the access criteria specify at least one location where at least one content processing device is authorized to descramble content signals and at least one location where at least one content processing device is not authorized to descramble content signals.

25. The content processing device of claim 14, wherein the access criteria further comprise a time period when the content processing device is authorized to descramble the content signal.

26. The content processing device of claim 14, wherein the content processing device comprises a set-top box.

27. The content processing device of claim 14, wherein the descrambler comprises a conditional access module, the conditional access module comprising a conditional access descrambler and a copy protection scrambler.

28. The content processing device of claim 14, wherein the content processing device is configured to transmit descrambled content signals to a display unit configured to display the descrambled content signals.

29. The content processing device of claim 14, further comprising:
a receiver coupled to the descrambler, the receiver being configured to receive scrambled content signals from at least one content provider; and
a demodulator coupled to the receiver, the demodulator being configured to demodulate the content signals received by the receiver.

30. The content processing device of claim 29, further comprising a storage device to store the scrambled content signals prior to descrambling.

31. The content processing device of claim 29, wherein the content signals are used to drive a projector.

32. The content processing device of claim 31, wherein the projector is configured to be used for Digital Cinema in a movie theater.

33. The content processing device of claim 29, wherein the content signals are used to drive a display in a public place.

34. The content processing device of claim 14, wherein the means for autonomously determining location comprises a Global Positioning System (GPS) receiver, and further comprising a secure source of time coupled to the processor, the secure source of time being used to verify an authenticity of a GPS signal received by the GPS receiver.

35. The content processing device of claim 14, wherein the means for autonomously determining location is packaged in a portable module.

36. The content processing device of claim 35, wherein the portable module is packaged as a PCMCIA type 2 form factor.

37. The content processing device of claim 35, wherein the portable module comprises a Global Positioning System (GPS) receiver and a secure source of time that is used to verify an authenticity of a GPS signal received by the GPS receiver.

38. The content processing device of claim 14, wherein the descrambler comprises a conditional access descrambler and a copy protection scrambler.

39. The content processing device of claim 14, further comprising a decoder coupled to the descrambler, the decoder being configured to decode descrambled content signals.

40. The content processing device of claim 14, wherein the GPS receiver is further configured to send a cryptographic signature with the determined location to the processor, the processor being configured to check the cryptographic signature to verify an authentic location determined by the GPS receiver.

41. The content processing device of claim 40, wherein the GPS receiver comprises an anti-tamper security perimeter.

42. The content processing device of claim 40, wherein the cryptographic signature uses public key cryptography.

43. The content processing device of claim 40, wherein the cryptographic signature uses secret key cryptography.

44. The content processing device of claim 40, wherein the cryptographic signature is a function of a random number generated and delivered by the processor.

45. A method of authenticating the location of a content processing device, the method comprising:
associating access criteria with content signals, the access criteria comprising at least one pre-determined Global Positioning System (GPS) location where a content processing device is authorized to decode content signals;
coding the content signals to prevent unauthorized content processing devices from accessing the content signals; and
delivering the content signals with the access criteria to at least one content processing device.

46. The method of claim 45, wherein associating access criteria with content signals comprises combining access criteria with content signals.

47. The method of claim 45, wherein the access criteria further comprises a time period when a content processing device is authorized to decode the content signal.

48. The method of claim 45, wherein delivering the content signals with the access criteria comprises wireless transmission.

49. The method of claim 45, wherein delivering the content signals with the access criteria comprises transmission via a cable network.

50. A method of authenticating the location of a content processing device, the method comprising:
receiving a plurality of Global Positioning System (GPS) signals from a plurality of GPS satellites at a content receiver;
determining a location of the content processing device based on the GPS signals; and
comparing the location based on the GPS signals with pre-determined access criteria, wherein (a) if the location based on the GPS signals meets the access criteria, then descrambling a set of content signals, (b) if the location based on the GPS signals does not meet the access criteria, then preventing the content signals from being descrambled.

51. The method of claim 50, further comprising receiving scrambled content signals from a content provider at the content processing device.

52. The method of claim 50, further comprising reading scrambled content from a media at the content processing device.

53. The method of claim 50, further comprising comparing a time when the GPS signals were received with a pre-determined access time criteria, wherein (a) if the time when the GPS signals were received meets the access time criteria, then descrambling the content signals, (b) if the time when the GPS signals were received does not meet the access time criteria, then preventing the content signals from being descrambled.

54. A conditional access device configured to be coupled to a content processing device, the conditional access device comprising:
a content descrambler configured to descramble scrambled content signals; and
a means of autonomously determining a location of the descrambler.

55. The device of claim 54, wherein the means of autonomously determining a location comprises a Global Positioning System (GPS) receiver that uses GPS signals to determine a location.

56. The device of claim 54, wherein the means of autonomously determining a location comprises a cellular signal receiver.

57. The device of claim 54, wherein the means of autonomously determining a location comprises a security perimeter.

58. The device of claim 57, wherein the device uses secret key cryptography to communicate outside the security perimeter.

59. The device of claim 57, wherein the device uses public key cryptography to communicate outside the security perimeter.

60. The device of claim 57, wherein the device is configured to use a secure time source to detect and discard false GPS signals.

61. The device of claim 57, wherein the device interfaces with a cryptographic CPU which has access to a secure time to detect and discard false GPS signals.
